(19) United States
(12) Patent Application Publication
(10) Pub. No.: US 2024/0171669 A1
(43) Pub. Date: May 23, 2024

(54) UNIVERSAL LIFE SAVING SYSTEM

(71) Applicant: GloBeam, Inc., Chatsworth, CA (US)

(72) Inventor: Yuh-Shen SONG, Porter Ranch, CA (US)

(21) Appl. No.: 18/513,356

(22) Filed: Nov. 17, 2023

Related U.S. Application Data
(60) Provisional application No. 63/426,334, filed on Nov. 17, 2022.

(51) Int. Cl. H04M 1/72421; H04W 64/00; H04W 76/50

(52) U.S. Cl. CPC H04M 1/72421; H04W 64/006; H04W 76/50; G08B 25/016

(57) ABSTRACT

A method for alerting a responder by a first component uses a voice recognition module of the first component to receive a verbal command from the person to send an alert, and uses a location module of the first component to identify location information of the person in response to the verbal command. The method also uses a video recorder of the first component to record environment information of the person in response to the verbal command, and uses a predefined communication protocol to send the alert, the location information, and the environment information to a second component through a communications network. The method uses an artificial intelligence module of the second component to analyze the alert, the location information, and the environment information to identify a method to rescue the person. A drone is instructed to rescue the person based on the identified method to rescue the person.

### CROSS-REFERENCE TO RELATED APPLICATION

The present application claims the benefit of U.S. Provisional Patent Application No. 63/426,334, filed on Nov. 17, 2022, and titled “UNIVERSAL LIFE SAVING SYSTEM,” the disclosure of which is expressly incorporated by reference in its entirety.

### TECHNICAL FIELD

The present disclosure relates generally to a life-saving system based on advanced technologies. More specifically, the present disclosure uses computer technologies, computer communication technologies, and computer networking technologies to protect individuals against life threats and emergency situations.

### BACKGROUND

People face various types of life threats and emergency situations. The following statistics are unpleasant to know, but they are the reality today. For example, young women are exposed to very high risks. According to a survey conducted in the United States by the Journal of Studies on Alcohol and Drugs, nearly 18 percent of women reported they had been raped while incapacitated by alcohol or drugs prior to college. The survey also revealed that approximately 15 percent of women reported they had been raped while incapacitated by alcohol or drugs during their first year in college.

Approximately 18.3 million women in the US are the victims of stalking during their lifetime. Additionally, approximately 5.7 percent (nearly 6.5 million) of US men experience stalking at some point in their life. Most of them are stalked by someone they know. These stalking victims may be traumatized by the stalkers for a long time and cannot return to normal life.

Senior people are exposed to many high risks. According to the U.S. Centers for Disease Control and Prevention (CDC), each year, millions of senior people fall. In fact, each year, more than one out of four seniors have reported a falling incident. Over 3 million senior people a year are treated in emergency departments for fall injuries. Over 800,000 patients a year are hospitalized because of a fall injury. The total medical costs for falls are more than $50 billion per year.

Cardiovascular diseases (CVDs) are heart and blood vessel conditions that remain the leading cause of premature death in the United States. Annually, over 800,000 people in the US have a heart attack. One in five heart attack victims did not know that he (or she) was at risk of a heart attack. All CVD-related expenses cost the US around $219 billion each year. By 2035, the medical costs and productivity losses are expected to reach about $1.1 trillion.

Even if a normal healthy person stays at home all the time, he (or she) can become a victim of burglary. According to FBI statistics, on average, a burglary happens once every 30 seconds in the United States. That adds up to two burglaries every minute and about 3,000 burglaries per day. Many burglaries have caused other additional crimes, such as assault, murder, raping, kidnapping, etc.

There are many other unpredictable risks. For example, over 500,000 people went missing in 2020 in the United States, and more than 300,000 were kids. One out of seven missing kids who never came back was probably a sex trafficking victim. There are approximately 40.3 million victims of human trafficking around the world, approximately 25% of them are children, and approximately 75% of them are women and girls.

Children in school are not free of risk. A study conducted by the US National Library of Medicine found that 24.7% of students bullied other students occasionally, while 2.8% did it very frequently. 49% of children in grades 4 to 12 had been bullied by other students at least once. For students who had been bullied, 29% reported being bullied in classrooms; 29% in the hallway or at their lockers; 23% in cafeterias; 12% in bathrooms; and 6% on the playground.

Even recreation is not free of risks. According to a study conducted by the Center for Disease Control and Prevention (CDC), over 200,000 people were treated each year in emergency departments for injuries caused by outdoor recreational activities, such as hiking, mountain biking, rock climbing, snowboarding, sledding, etc. Of those injured, more than fifty percent were young people. For both men and women of all ages, the most common injuries were fractures (27.4 percent) and sprains (23.9 percent). Of these, most injuries were to the arms or legs (52 percent) or to the head or neck (23.3 percent). Overall, 6.5 percent of outdoor injuries treated were diagnosed as traumatic brain injury (TBI)

The serious problems described above do not just exist in the United States alone. Similar or worse problems exist in every country worldwide. We live in a world that has many different types of life threats and emergency situations. There have been no solutions to tackle these problems.

Medical alert systems have been available for many years. However, medical alert systems are designed for people with known medical conditions. For example, a patient may carry a medical alert device after recovering from a stroke. Once the patient pushes the button on the medical alert device, the security company which provides the medical alert device can search its database to find the stroke history of the patient, then call an ambulance to rescue the patient. The cost of using a medical alert device is high because the user needs to pay the security company an ongoing fee to have such services. Most people simply cannot afford it.

Moreover, medical alert systems can only cover a very limited geographic area, such as within 1,000 feet of the communication hub installed at the home of the user. When a user pushes a button on his medical alert device, the device communicates with the hub through wireless communication. Then, the hub will send the alert signal to the security company which provides the medical alert device. Therefore, the person is not protected if he goes out of a limited geographic area. For example, if the person walks to a park far away from home, the medical alert device may not work anymore. Users of medical alert devices live like those people who are ordered by the judges to stay at home.

Furthermore, life threats and emergency situations have a much broader scope and are more complicated than medical alerts because life threats and emergency situations can happen unexpectedly in any form at any time without any prior indicator or history. For example, the victims of kidnapping, stalking, sexual assaults, robbery, etc., did not know in advance that they would become the victims of the crimes. They also may not have any chance to explain their situations when the incidents suddenly happen. None of these victims would have carried a device similar to the medical alert device. None of them would have hired a security company to constantly monitor them for security protection. For example, according to the statistics, one in five heart attack victims did not know that he (or she) had a heart attack risk. They would not have spent money to use medical alert devices before their first heart attack. Therefore, medical alert devices cannot truly be used as a universal solution to resolve many different types of life threats and emergency situations.

In fact, at the time of the present disclosure, there is no solution that can handle, eliminate, or mitigate many different types of life threats and emergency situations. Even global leaders have not figured out how to protect their people from life threats or emergency situations.

It is desirable to use a combination of advanced technologies to build a better world so that people can handle, eliminate, or mitigate many different types of life threats and emergency situations.

Although a universal life saving system (ULSS) is used as an example in the present disclosure, the combination of the computer technologies, communication technologies, and computer networking technologies described in the present disclosure can be used for many other applications.

SUMMARY

This disclosure includes a number of aspects that can be combined together to form a variety of computer systems and methods.

In some aspects of the present disclosure, a computer communication network-based process can save lives by receiving, at a first computer system from a sconed computer system, an alert and related information which is electronically collected by the second computer system associated with an alert sender; searching, by the first computer system, a database to identify contact information of a third computer system associated with a responder; sending, from the first computer system to the third computer system, the alert and the related information at least partially based on the contact information of the third computer system; receiving, at the first computer system from the third computer system, a message; and enabling, by the first computer system, a Voice-over-IP or SIP communication channel between the second computer system and the third computer system in response to the message.

In some aspects of the present disclosure, a computer communication network-based process can save lives by receiving, at a first computer system from a sconed computer system, an alert and related information which is electronically collected by the second computer system associated with an alert sender; searching, by the first computer system, a database to identify contact information of a third computer system associated with a responder; sending, from the first computer system to the third computer system, the alert and the related information at least partially based on the contact information of the third computer system; receiving, at the first computer system from the third computer system, a message; and sending, by the first computer system, the alert and the related information to a fourth computer system associated with a third-party service provider in response to the message.

Any of the computer systems described above comprises at least one of a computer system, a personal communications device, a mobile phone, a device interface, or a combination thereof.

The device interface described above comprises a keyboard, a keypad, a monitor, a display, a terminal, a computer, a computer server, a control panel, a vehicle dash board, a network interface, a machinery interface, a video interface, an audio interface, an electrical interface, an electronic interface, a magnetic interface, an electromagnetic interface including electromagnetic wave interface, an optical interface, a light interface, an acoustic interface, a video interface, an audio interface, a contactless interface, a mobile phone interface, a smartphone interface, a smartbook interface, a tablet interface, other communication device interface, a Personal Digital Assistant (PDA) interface, a handheld device interface, a portable device interface, a wireless interface, a wired interface, and other interfaces.

The above universal life saving system (ULSS) is merely an example. Many other systems can be formed by combining and rearranging the aspects of this disclosure.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE FIGURES

The features, nature, and advantages of the present disclosure will become more apparent from the detailed description set forth below when taken in conjunction with the drawings.

FIG. 1 illustrates a system and network diagram of a Universal Life Saving System (ULSS) according to aspects of the present disclosure.

FIGS. 2, 3, 4, 5, and 6 illustrate flow diagrams for the ULSS according to aspects of the present disclosure.

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. As described, the use of the term “or” may mean either “inclusive OR” or “exclusive OR,” depending on the situation of the application based on the convention.

### DETAILED DESCRIPTION

Some aspects of the present disclosure are directed to the universal life saving system (ULSS), which empowers individuals worldwide to effectively handle, eliminate, or mitigate life threats and emergency situations based on advanced computer technologies, computer communication technologies, and computer network technologies.

Various aspects of the present disclosure describe the ULSS as a tool for eliminating, mitigating, and/or handling life threats and emergency situations. However, the various aspects of the present disclosure, which include a combination of the computer technologies, communication technologies, and computer networking technologies described in the present disclosure can be used for many other applications.

People face various types of life threats and emergency situations. The following statistics are unpleasant to know, but they are the reality today. For example, young women are exposed to very high risks. According to a survey conducted in the United States by the Journal of Studies on Alcohol and Drugs, nearly 18 percent of women reported they had been raped while incapacitated by alcohol or drugs prior to college. The survey also revealed that approximately 15 percent of women reported they had been raped while incapacitated by alcohol or drugs during their first year in college.

Approximately 18.3 million women in the US are the victims of stalking during their lifetime. Additionally, approximately 5.7 percent (nearly 6.5 million) of US men experience stalking at some point in their life. Most of them are stalked by someone they know. These stalking victims may be traumatized for life.

Senior people are exposed to many high risks. According to the U.S. Centers for Disease Control and Prevention (CDC), each year, millions of senior people fall. In fact, each year, more than one out of four seniors have reported a falling incident. Over 3 million senior people a year are treated in emergency departments for fall injuries. Over 800,000 patients a year are hospitalized because of a fall injury. The total medical costs for falls are more than $50 billion per year.

Cardiovascular diseases (CVDs) are heart and blood vessel conditions that remain the leading cause of premature death in the United States. Annually, over 800,000 people in the US have a heart attack. One in five heart attack victims did not know that he (or she) had a heart attack risk. All CVD-related expenses cost the US around $219 billion each year. By 2035, the medical costs and productivity losses are expected to reach about $1.1 trillion.

Even if a normal healthy person stays at home all the time, he (or she) can become a victim of burglary. According to FBI statistics, on average, a burglary happens once every 30 seconds in the United States. That adds up to two burglaries every minute and about 3,000 burglaries per day. Many burglaries have caused other additional crimes, such as assault, murder, raping, kidnapping, etc.

There are many other unpredictable risks. For example, over 500,000 people went missing in 2020 in the United States, and more than 300,000 were kids. One out of seven missing kids who never came back was probably a sex trafficking victim. There are approximately 40.3 million known victims of human trafficking around the world, approximately 25% of them are children, and approximately 75% of them are women and girls.

Children in school are not free of risk. A study conducted by the US National Library of Medicine found that 24.7% of students bullied other students occasionally, while 2.8% did it very frequently. 49% of children in grades 4 to 12 had been bullied by other students at least once. For students who had been bullied, 29% reported being bullied in classrooms; 29% in the hallway or at their lockers; 23% in cafeterias; 12% in bathrooms; and 6% on the playground.

Even recreation is not free of risks. According to a study conducted by the Center for Disease Control and Prevention (CDC), over 200,000 people were treated each year in emergency departments for injuries caused by outdoor recreational activities, such as hiking, mountain biking, rock climbing, snowboarding, sledding, etc. Of those injured, more than fifty percent were young people. For both men and women of all ages, the most common injuries were fractures (27.4 percent) and sprains (23.9 percent). Of these, most injuries were to the arms or legs (52 percent) or to the head or neck (23.3 percent). Overall, 6.5 percent of outdoor injuries treated were diagnosed as traumatic brain injury (TBI)

It is desirable to use a combination of advanced technologies to build a better world so that people can handle, eliminate, or mitigate different types of life threats and emergency situations. Various aspects of the present disclosure are directed to the ULSS that mitigates, eliminates, or hanldes life threats and emergency situations that may cause bodily harm and/or other types of harm to a person or a society.

Particular aspects of the subject matter described in this disclosure can be implemented to realize one or more of the following potential advantages. In some examples, the described techniques may improve emergency response time by putting an alert sender in contact with a pre-defined responder, wherein the responder has a personal knowledge of (e.g., a relationship with) the alert sender. Such techniques compliment services provided by emergency personnel and allow non-emergency personnel to respond to emergency situations.

In some aspects of the present disclosure, the ULSS includes a robotic team, which consists of, for example, drones, robotic dogs, robotic security officers, robotic medical expert, driverless cars, etc., that are dispatched and controlled by the central computer system of the ULSS so that the ULSS can timely eliminate, mitigate, or handle life threats and emergency situations.

In some aspects of the present disclosure, the ULSS uses a robot control module to direct robots to take action in a rescue mission. For example, the ULSS uses a drone control module to direct drones in a rescue mission.

With the help of artificial intelligence, it is likely that one or more members of the robotics team may move faster and rescue more precisely than the traditional emergency personnel. Therefore, the ULSS may eventually fill the needs for the traditional emergency personnel that are in shortage today.

In some aspects of the present disclosure, the ULSS includes a computer network connecting a group of components. In some examples, the group of components may include a computer system used by an alert sender (e.g., alert computer system), a computer system used by a responder (e.g., responder computer system), a computer system used by a third-party service provider (e.g., third-party computer system), a computer system used by the robotic team (e.g., robotic team computer system), and a central computer system that controls and facilitates communications and actions by the other computer systems, such as the alert computer system, the responder computer system, the third-party computer system, and the robotic team computer system.

Each one of the alert computer system, the responder computer system, the third-party computer system, and the robotic team computer system may be a type of device interface, including a portable computer system, such as a mobile phone. The central computer system may be a type of device interface, including a standard server system which may consist of an application server and a webserver. The central computer system may reside on a cloud, such as Microsoft Azure™, IBM™ cloud, Amazon™ cloud, etc.

In some aspects of the present disclosure, the computer system used by the alert sender includes one or more of a computer system, a personal communications device, a mobile phone, or a device interface.

In some aspects of the present disclosure, the computer system used by the responder includes one or more of a computer system, a personal communications device, a mobile phone, or a device interface.

In some aspects of the present disclosure, the computer system used by the third-party service provider includes one or more of a computer system, a personal communications device, a mobile phone, or a device interface.

In some aspects of the present disclosure, the computer system used by the robotic team includes one or more of a computer system, a personal communications device, a mobile phone, or a device interface.

In some aspects of the present disclosure, the central computer system includes one or more of a computer system, a personal communications device, a mobile phone, or a device interface.

In some examples, a communication protocol is established for the communications among these five computer systems (e.g., the central computer system, the alert computer system, the responder computer system, the third-party computer system, and the robotic team computer system). Software may be developed for each of the computer systems so that the five computer systems communicate with one another through a combination of computer networks, including local area network, wide area network, wired network, wireless network, intranet, Internet, phone network, and any other type of computer communication network.

In some examples, a person registers with the ULSS before the person can use the ULSS. During the registration process, the ULSS collects one or more pieces of personal identification information of the person (e.g., name, ID number, address, etc.) and one or more pieces of contact information of the person (e.g., phone number, e-mail address, IP address, etc.)

In some examples, a person can send an alert to a responder through the ULSS. In such examples, the responder is registered with the ULSS, such that the responder can receive the alert from the sender. An alert sender may be associated with one or more responders. In some examples, the alert sender is linked to one or more responders prior to sending an alert via the ULSS to the responders.

In some aspects of the present disclosure, an alert sender may send an alert with accompanying information from a mobile device (e.g., mobile phone) associated with the alert sender. The mobile device may be an example of the alert computer system. In some examples, the accompanying information may include location information of the alert computer system. The location information may be obtained from a location module, such as a global positioning system (GPS) module and/or a cellular geolocation module incorporated with the alert computer system.

The location information of the alert sender is extremely important. In 2013, nineteen fire fighters were killed when they tried to put out the wild fire in Arizona. The fatal cause was that the smoke was so thick that the people who were on the helicopter with the mission to rescue them could not find them. If the rescue team had the location information (e.g., GPS information or cellular geolocation information), those fire fighters could have been saved.

In some examples, the accompanying information may include environmental information of the alert computer system. The environmental information may be obtained from a video recorder, an audio recorder, and/or a camera incorporated with the alert computer system. The environmental information is extremely valuable. For example, a recorded voice of the alert sender may tell the responder the license plate number of the kidnapper's car.

For ease of explanation, an alert message may be used to describe the alert and the accompanying information. The alert message may be transmitted from a mobile phone network to the Internet, then to a local area network at a cloud center, then to a central computer system of the ULSS residing at the cloud center. The central computer system may use a pre-defined computer communication protocol to receive the alert and the accompanying information. The central computer system may use the alert sender information to identify associated responder information stored at the central computer system or an associated database. The responder information may include responder contact information, such as an IP address, a phone number, or an e-mail address, associated with the responder. The central computer system may transmit the alert message to a device associated with the responder based on the responder's contact information. The alert and the accompanying information may be transmitted, for example, through the local area network of the cloud center, then the Internet, then the local network of the responder's home, then the mobile phone of the responder. The central computer system and the different communication networks are transparent to the alert sender and the responder.

In some aspects of the present disclosure, the central computer system may use an artificial intelligence module to understand and analyze the alert sender's situation based on the alert message, then determine whether to dispatch the robotic team and how to use the robotic team to save the alert sender in time.

Different combinations of networks can be used to send an alert signal from the alert sender to the responder. The pre-defined communication protocol may determine how the alert message is handled by different computer systems and how different networks are selected to accomplish the data transmission.

In some aspects of the present disclosure, the ULSS can send an alert to the responders based on a voice command. In some examples, an alert sender may generate a voice command in response to a life threat, an emergency, or a risk. In such aspects, a voice recognition module may be incorporated into the alert computer system, such that the alert computer system can transmit an alert message in response to receiving a verbal command. The alert computer system may be an example of a mobile device or other device associated with the alert sender. The voice recognition module may be triggered based on one or more alert words, the one or more alert words may include one or more key words or one or more specific commands, such as “send alert,” “emergency,” or “help.” The voice recognition module may cause the alert computer system to transmit the alert based on identifying the one or more alert words. In some examples, the voice recognition module may be trained to only respond to the alert sender's voice to prevent false alarms.

In some aspects of the present disclosure, after the responder computer system has received the alert message, the alert sender and the responder can communicate, via voice (e.g., verbally), to each other via their respective device through the ULSS. In some examples, the communication channel may be a data communication channel (e.g., Voice-over-IP) that is established via the ULSS without making a phone call through the phone network. In some examples, the communication channel may be established between a combination of the alert computer system, the responder computer system, the third-party computer, and the robotic team computer system. In some examples, a data communication module, such as a Voice-over-IP module or SIP module, may be incorporated into the alert computer system, the responder computer system, the third-party computer system, and the robotic team computer system to convert analog voice signals into data packets that are sent through the computer communication networks. The data communication module may also convert the data packets back to the analogy voice signals.

In some aspects of the present disclosure, the voice communication among the alert sender, the responder, the third-party service provider, and the robotic team is encrypted to protect the contents of the communications. Therefore, a data encryption module may be incorporated into the alert computer system, the responder computer system, the third-party computer system, and the robotic team computer system to encrypt and/or decrypt the voice data.

In some aspects of the present disclosure, after sending the alert message, the ULSS may continue to inform the responder, the third-party service provider, and/or the robotic team of the location information and the environmental information of the alert sender. As discussed, a location module, such as a GPS module or cellular geolocation module, may be incorporated into the alert computer system. The location module may also be incorporated with the responder computer system, the third-party computer system, and the robotic team computer system, such that the alert sender's location information may be received and processed by the respective computer systems. In some examples, driving directions can be derived and displayed on the computer systems (e.g., mobile phones) associated with one or more of the alert sender, the responder, the third-party service provider, and the robotic team so that they can take an action to save or help the alert sender.

In some examples, if a computer system, such as the responder computer system, the alert computer system, the third-party computer system, or the robotic team computer system is connected to an autonomous or semi-autonomous vehicle, the vehicle may autonomously navigate to the location of the alert sender.

Similarly, drones, robotic dogs, robotic security officers, robotic medical experts, driverless cars, etc., can quickly move to the location of the alert sender once they have received the location information of the alert sender from the ULSS.

For example, if an alert sender is caught in the middle of a forest fire, the ULSS can send a drone to pour water on the fire surrounding the alert sender based on the location information of the alert sender. Alternatively, the drone can drop a rescue chair with a rope fastening the chair to the drone so that the alert sender can sit on the chair and let the drone to pull him up and fly away from that area.

For example, if a stalker is following the alert sender, the ULSS can send a drone which carries a robotic security officer so that the robotic security officer can quickly reach the alert sender based on the location information of the alert sender to protect the alert sender.

For example, if the alert sender is having a heart attack, the ULSS can send a drone which carries a robotic medical expert so that the robotic medical expert can quickly reach the alert sender based on the location information of the alert sender to save the alert sender.

For example, if the alert sender is kidnapped and locked inside a moving car, the ULSS can send a drone which carries a robotic security officer so that the drone will identify the moving car and let the robotic security officer set up a roadblock to stop the moving car to save the alert sender.

In some aspects of the present disclosure, once the message of the alert sender is received, the ULSS can use an Artificial Intelligence module to analyze and understand the situation of the alert sender and dispatch the robotic team to rescue the alert sender based on the location information of the alert sender.

In some aspects of the present disclosure, the ULSS continues to communicate with the robotic team to understand the most up-to-date status and inform the alert sender and responders of the status.

Moreover, one or more audio/visual (AV) devices, such as one or more of a video camera, a front facing camera, a rear facing camera, a video recorder, or an audio recorder, may be incorporated into the computer systems of the alert sender, the responder, the third-party service provider, and the robotic team. In some examples, one or more AV devices at the alert computer system may begin recording in response to an alert sender generating an alert at the alert computer system. In some such examples, both a front facing camera and rear facing camera of the alert computer system may record in response to the alert sender generating the alert. Each AV device may record for a pre-determined period of time. The captured content, such as the captured recordings, photos, and/or audio, may be included in the alert message.

In some aspects of the present disclosure, a life threat, an emergency, or a risk can be caused by a medical condition, an accident, a dangerous condition, a criminal activity (such as robbery, burglary, stalking, kidnap, rape, assault, etc.), a risky situation (such as an unwelcome touch, a body contact, an abusive treatment, a sexual violation, a quarrel, a domestic violence, a fight, a gunshot, a fire alarm, etc.), or any other unexpected emergency situations.

In some aspects of the present disclosure, the responders can be the alert sender's parents, adult children, spouse, siblings, loved ones, relatives, friends, neighbors, assistants, bodyguards, doctors, nurses, or whoever is willing and able to save the alert sender or get the alert sender out of the emergency or problematical situations.

Sending an alert through the ULSS is different from calling a government emergency number, such as 911. For example, due to limited resources, emergency personnel may not be able to prioritize the alert sender's emergency. In some cases, emergency personnel may fail to show up after a person has made one or more 911 calls. In many areas, the police personnel may only show up after a major crime, such as a murder, has been committed. If a crime has yet to occur, the emergency personnel may not show up. As a result, emergency personnel may show up too late to save or help the victims.

As an example, if a woman calls 911 and reports that someone is following her on the street, the 911 team may advise her to walk to the nearest police station. However, no police personnel will show up to protect her when she is walking to the police station. In comparison, if she sends an alert through the ULSS Alert, her responders may immediately show up to protect her.

As another example, if a woman feels she may be intoxicated in a bar or a restaurant, no police personnel will show up to protect her if she makes a 911 call. However, her responders will show up and help her get home safely after she transmits an alert through the ULSS to the responders.

As another example, if a girl encounters a sudden nonconsensual sexual advance by an offender, she may not have the opportunity to call 911. However, she may transmit an alert via the ULSS to her responders. It is possible that the offender may stop the advance and run away after seeing that she has generated an alert.

As another example, if a child is bullied in the school, the 911 team may not send police personnel to protect the child. However, the child may transmit an alert via the ULSS to the responders who may immediately show up to protect the child.

As another example, if a young man falls down from a cliff during mountain biking, although he cannot move anymore, he may transmit an alert via the ULSS to the responders who may immediately locate him and launch a rescue mission.

As another example, if a child gets lost in an unfamiliar area, the child may transmit an alert via the ULSS to the responders who will immediately locate the child and send the child home.

As another example, if a man feels that he is having a heart attack, although he cannot move anymore, he may transmit an alert via the ULSS to the responders who will immediately send medical personnel to save him.

Moreover, in some examples, because the emergency personnel do not personally know the alert sender, they may not be able to meet the alert sender's specific needs. Personal knowledge of the alert sender may be crucial when there is a special medical condition. In comparison, the responders may have personal knowledge about the alert sender and may take precise actions to save or help the alert sender.

Additionally, in some examples, an alert sender may need time to explain the situation to the emergency personnel. However, the alert sender may not have the time to explain the situation in the event of an emergency. In comparison, the responders do not need any explanation from the alert sender because of their relationship with the alert sender. For example, a parent may respond to a child with no explanation necessary if the child indicates he/she is in an emergency.

If needed, the responders may call emergency personnel, such as 911, a doctor, or the police, to explain the situation on behalf of the alert sender.

Furthermore, if an alert sender cannot reach the alert computer system (e.g., a mobile device), the alert sender may also be prevented from calling emergency personnel. In comparison, because the alert sender can remotely send an alert through the ULSS via a voice command, the responders can still receive the alert from the ULSS even if the alert sender cannot reach the alert computer system.

Additionally, after the alert sender sends an alert through the ULSS, the ULSS helps responders identify the location and/or the environmental condition of the alert sender. The ULSS also helps the responders track the movement of the alert sender and provides them with driving directions so that they can quickly rescue the alert sender or get the alert sender out of risks or problematical situations. The location information may be useful in a variety of situations. For example, an alert sender may be unaware of an address of a house party. However, if the alert sender transmits an alert via the ULSS due to an emergency at the party, the ULSS may inform the responders of the address of the party location so that the responders can arrive at the correct location.

The responders associated with the alert sender are the people that may have a personal relationship with the alert sender and may know the alert sender very well. They may be willing to do more than what the emergency personnel can do for the alert sender. The ULSS also helps responders quickly find the alert sender and save or help the alert sender in time.

In some examples, the ratio of a number of police officers to a population in an area may be, for example, 1 to 1,000. This means that one police officer needs to take care of 1,000 people. A person in that area can only get about 0.1% of the attention from the police personnel. In comparison, the same person can have multiple responders to take care of him (or her) and may receive their full attention through the ULSS.

Aspects of the present disclosure are not intended to limit a person's ability to call emergency personnel. Rather, aspects of the present disclosure are intended to compliment the services provided by emergency personnel and provide an alternative to the services provided by emergency personnel.

Aspects of the present disclosure may limit a number of responders associated with a person (e.g., alert sender). This limitation may reduce the overhead of the central computer system. Still, in most cases, an alert sender may be associated with a group of responders and each one of the group of responders may receive the alert message.

In some aspects of the present disclosure, to prevent multiple responders from arriving at a location of the emergency, one responder may indicate that he is responding to the emergency. In such examples, the indication may be broadcast, via the ULSS, to the other responders in the group. Additionally, or alternatively, the indication may be transmitted to the alert sender, such that the alert sender is aware that at least one responder is responding to the alert.

As discussed, a person may send an alert through the ULSS under many different situations. As an example, an alert sender may transmit the alert message whenever they believe their life is in danger.

In some examples, an alert sender may transmit the alert message in response to one or more of: encountering a criminal or a kidnapper; an accident; encountering a stalker; a robbery; intoxication; incoherence; incapacitation; being drugged by another person; being uncomfortable with a situation (e.g., an unwelcome touch, a body contact, an abusive treatment, a sexual violation, a quarrel, domestic violence, an assault, a fight, a gunshot, a fire alarm, etc.); or being suspicious of an intent of another person. There are many other potentially life-threatening, emergency, or risky situations that may cause a person to send an alert message via the ULSS. Aspects of the present disclosure do not restrict when a person can send an alert through the ULSS. An alert sender can transmit the alert message via the ULSS whenever they need help.

As discussed, in some aspects of the present disclosure, a person can verbally command his (or her) phone to send an alert through the ULSS. Additionally, or alternatively, the alert sender can also quietly send an alert message via the ULSS by providing a tactile or non-tactile input to the alert computer system, such as a mobile phone.

As discussed, after sending the alert message to the responders, the ULSS may periodically, such as at an interval, transmit the location information and the environmental information of the alert sender to all responders. The periodic updates may be frequent, such that it may appear that the location updates are continuous. The location information helps the responders quickly track and find the alert sender. The environmental information is transmitted via information captured via one or more AV devices. For example, the environmental information may include one or more of a video clip, a photo, or a recorded sound. The location information and the environmental information may provide valuable data in many cases.

In some aspects of the present disclosure, one or more of a photo camera module, a video camera module, a video recording module, or an audio recording module may be incorporated into one or more of the alert computer system, the responder computer system, the third-party computer system, or the robotic team computer system.

In some aspects of the present disclosure, the responder computer system enables the responder to send the location information of the alert sender to another computer system. This function enables the responder to report the alert sender's location information to law enforcement officers, medical emergency personnel, and other people who can help or rescue the alert sender.

In some aspects of the present disclosure, the responder computer system enables the responder to send the environmental information (e.g., photo, video, voice message, etc.) of the alert sender to another computer system. This function enables the responder to report alert sender's environmental information to law enforcement officers, medical emergency personnel, and other people who can help or rescue the alert sender.

In some aspects of the present disclosure, a computer communication module and a network interface module are incorporated into the computer systems of the alert sender, the responders, the third-party service providers, and the robotic team so that they can communicate with the central computer system.

In some examples, after an alert sender has transmitted the alert message via the ULSS, the alert sender may hold the alert computer system toward a suspicious person or perpetrator to obtain a recording of the person's face. The recording may then be transmitted to the responders. In addition, a display of the alert computer system may show the person that the ULSS Alert has been triggered and it is better for the person to go away.

In some examples, an alert sender may move the alert computer system around a location to capture all of the surrounding people. In some other examples, the alert sender may record a scene of an accident and send the recording to the responder.

In some examples, the sound of the video clip may contain a crucial voice message, such as ‘I have fallen in my bathroom and cannot move anymore,’ ‘The kidnapper has a black car with a license plate 3B27G6,’ or ‘John Doe is attacking me.’

In some aspects of the present disclosure, an alert sender may disable the alert by selecting a “Stop” button on the alert computer system. One can imagine that a criminal will immediately stop the alert after seizing the victim's phone. Therefore, the ULSS has included a special “Protection Period” to protect the victim. In some aspects of the present disclosure, the Protection Period starts after the “Stop” button has been tapped. There is a default length of the Protection Period, such as 30 minutes. A person has an option to extend the default length. In some aspects of the present disclosure, during the Protection Period, the ULSS continues to send alert sender's location information and environmental information to the responders.

In some aspects of the present disclosure, regardless of whether the “Stop” button has been tapped or not, all activities of an alert will automatically stop after a pre-defined period of time, such as 24 hours, 48 hours, 72 hours, etc. This auto-stop function intends to reduce the overhead to the central computer system when an alert sender forgets to stop the alert. The responders should have already taken the necessary actions to save or help the alert sender before the alert stops.

In some aspects of the present disclosure, when a responder selects a received alert sent through the ULSS to read the alert details, the ULSS will inform the alert sender that the responder has received the alert.

In some aspects of the present disclosure, a person can add a responder by using the responder's ID information, e-mail address, phone number, or any other information that can uniquely identify the responder. The ULSS will ask the responder to confirm whether he (or she) is willing to be the responder for the person. If the responder agrees, the ULSS will register him/her as a responder.

In some aspects of the present disclosure, the ULSS has a test module to test whether a responder has been added correctly. In some aspects of the present disclosure, a person can select a “Test” button on his (or her) computer system. During the test, the ULSS will not send an alert through the ULSS to all responders. Only the selected responder will receive a test signal from the ULSS. The selected responder can select a “Successful” button to confirm that he (or she) has successfully received the test signal from the ULSS. The ULSS will also inform the test alert sender that the test is successful.

In some aspects of the present disclosure, when either a person or the person's responder terminates the responder relationship, the ULSS will immediately inform the other party so that a replacement can be quickly arranged. A person may want to have multiple responders so that the impact of such termination is minimized.

In some aspects of the present disclosure, the ULSS has a special interface for third parties, such as security companies, hospitals, etc., so that these third parties can provide their services to their clients through the ULSS.

In some aspects of the present disclosure, after the responder receives an alert from the ULSS, the responder has several options to take action in response to the alert. For example, if the alert sender fell down in the bathroom at his own home and could not move anymore, the responder may request the ULSS to enable a voice communication channel so that the responder can directly talk with the alert sender to find out his current condition, then decide what to do next.

For example, if the alert sender is having a heart attack, the responder may want to contact the emergency department of a hospital. Under such circumstances, the ULSS may provide direct three-party communication among the alert sender, the responder, and the emergency department.

In some aspects of the present disclosure, a voice data communication module (e.g., Voice over IP module, or Session Initiation Protocol (SIP) module) is incorporated into the computer systems of the alert sender, the responder, the third-party service providers, and the robotic team so that they can communicate among each other through the ULSS. In addition, the responder can instruct the ULSS to send the alert sender's location information and environmental information to the emergency department of the hospital.

For example, if the alert sender has been kidnapped but has hidden her mobile phone in her pocket, the responder may not want to enable voice communication which may unnecessarily attract the attention of the kidnapper who may take away the mobile phone from the alert sender. Under such circumstances, the responder may request the ULSS to quietly inform the alert sender via a text message that the responder has already received the alert.

The applications of the present disclosure have established a ubiquitous system based on a computer communication network, which may consist of a combination of wireless networks and wired networks. A communication protocol is established to facilitate the communication among the computer systems on the computer communication network.

The central computer system is the control and communication center of the network. The communication may consist of a group communication when the alert sender, the responders, the third-party service providers, and the robotic team are communicating among themselves. The communication may also consist of a point-to-point communication, when a specific pair of parties communicate with each other. The communication among the computer systems on the network can be achieved through text message, e-mail, voice, video, file transfer protocol (FTP), or any communication method that is available for computer communication purposes.

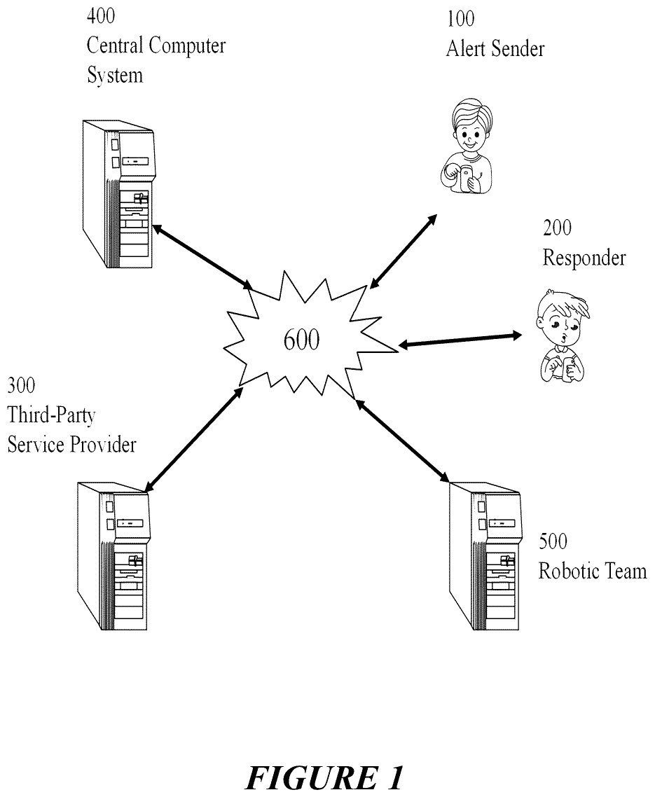

FIG. 1 illustrates an example of the ULSS, which includes the central computer system 400 (e.g., a device interface) and a computer network 600, such as a combination of mobile phone networks, Internet, and local area networks, according to aspects of the present disclosure.

In one configuration, an alert sender 100 has an accident and cannot move anymore. The alert sender 100 sends an alert message through the ULSS. The central computer system 400 sends an alert to the responder 200, and the responder 200 requests the central computer system 400 to enable the responder 200 to contact a Third-Party Service Provider 300 (e.g., an emergency department of a hospital) to rescue the alert sender 100.

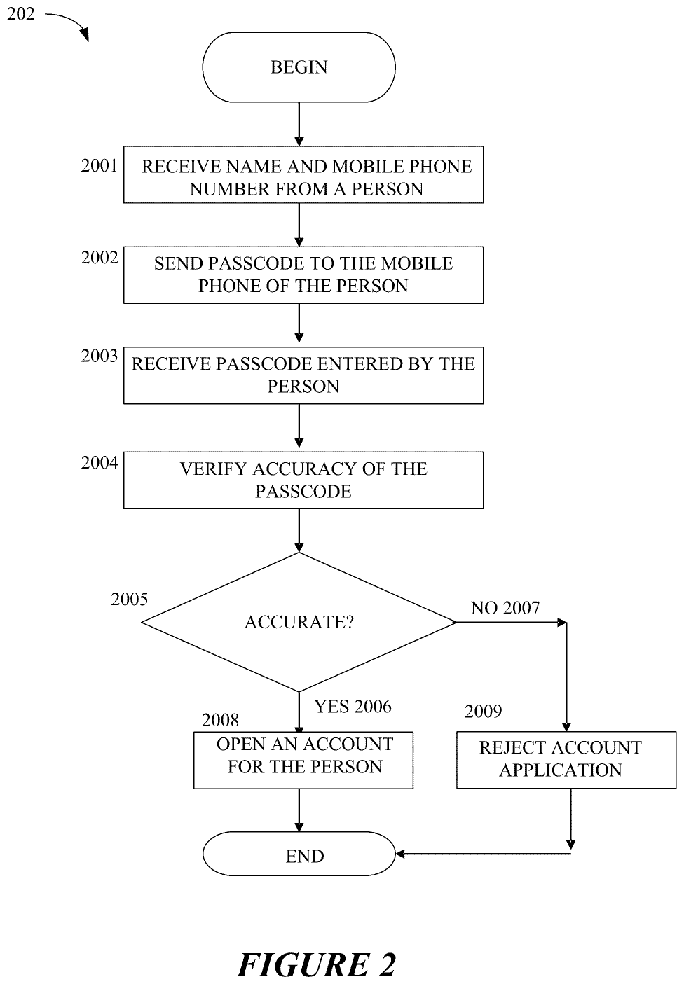

FIG. 2 is a flow diagram illustrating an example of a process 202 for opening an an account with the ULSS according to aspects of the present disclosure. In the example of FIG. 2, an alert sender 100 and the responder 200 have installed a mobile app on the alert sender computer system and the responder computer system, respectively. The mobile app is a component of the ULSS. The mobile app controls various functions of the alert sender computer system to support the operations of the ULSS. FIG. 2 refers to an alert sender 100 as a person that is installing the mobile app. For ease of explanation, this person may be referred to as the alert sender 100 even though they have yet to transmit an alert.

The alert sender 100 needs to download the ULSS mobile app to open an account with the ULSS. As shown in FIG. 2, at block 2001, the central computer system (e.g., a device interface) 400 receives the name and the mobile phone number from a person (e.g., alert sender 100). At block 2002, the central computer system 400 sends a randomly-generated passcode to the alert sender computer system (e.g., mobile device) via a text message based on a mobile phone number provided by the alert sender 100. At block 2003, the central computer system 400 prompts the alert sender 100 to enter the passcode. As a result, the central computer system 400 receives the passcode entered by the alert sender 100. At block 2004, the central computer system 400 verifies whether the passcode entered by the alert sender 100 is accurate.

After the verification, the central computer system 400 may take one of two different actions based on the verification result (decision block 2005). If the passcode provided by the alert sender 100 is not accurate (NO branch 2007), the central computer system 400 will reject the account application (block 2009). If the passcode provided by the alert sender 100 is accurate (YES branch 2006), the central computer system 400 opens an account for the alert sender 100 at block 2008. After this account opening process, the central computer system 400 has collected, verified, and stored in its database the name, the mobile phone number, and the address of the mobile phone of the alert sender 100.

The responder 200 needs to download the ULSS mobile app to open an account with the ULSS. The central computer system 400 can open an account for responder 200 based on a similar approach, as shown in FIG. 2. After the account opening process, the central computer system 400 has collected, verified, and stored in its database the name, the mobile phone number, and the address of the mobile phone of the responder 200.

In some examples, the alert sender 100 can request the central computer system 400 to invite the responder 200 to become her responder. After the responder 200 has accepted the invitation, the central computer system 400 will record in its database that the responder 200 is associated with the alert sender 100.

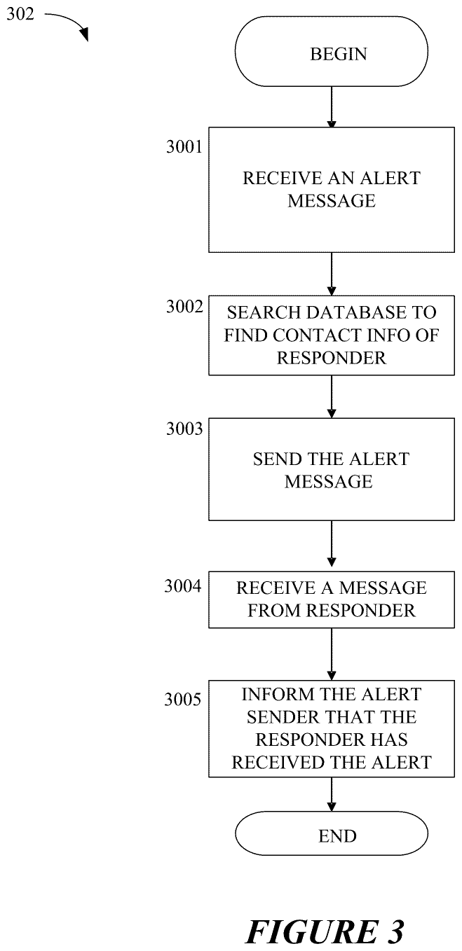

FIG. 3 is a flow diagram illustrating an example of a process 302 of the ULSS after the alert sender 100 was involved in an accident.

In the example of FIG. 3, the alert sender 100 sends an alert message to responder 200 via the mobile application installed on the alert computer system. The alert sender 100 may generate an alert at the alert computer system. Then, the alert computer system may transmit an alert message to the central computer system 400. The alert message may include the alert, the location information of alert sender 100, and a video clip taken by the alert computer system. As a result, the central computer system 400 receives the alert message (block 3001). As discussed, the alert message may include the alert, the location information, and the environmental information (e.g., the video clip taken by the mobile phone of alert sender 100).

In response to receiving the alert message, the central computer system 400 searches its database to identify the responder 200. Additionally, the central computer system 400 obtains the contact information (e.g., the mobile phone number, mobile phone address, etc.) of the responder 200 from a database (block 3002). The central computer system 400 sends the alert message to the responder computer system (block 3003). The mobile app on the responder computer system is a part of the ULSS.

After the responder 200 receives the alert, the location information of alert sender 100, and the video clip taken by the mobile phone of alert sender 100, the responder 200 can select one or more options provided by the ULSS. As a result, the central computer system 400 receives a message from the responder computer system (block 3004).

In the example of FIG. 3, in response to the option selected by responder 200, the central computer system 400 informs the alert sender 100, via the mobile app on the alert computer system, that the responder 200 has received the alert message (block 3005). This indicates that responder 200 may start to perform his duty as the responder for alert sender 100.

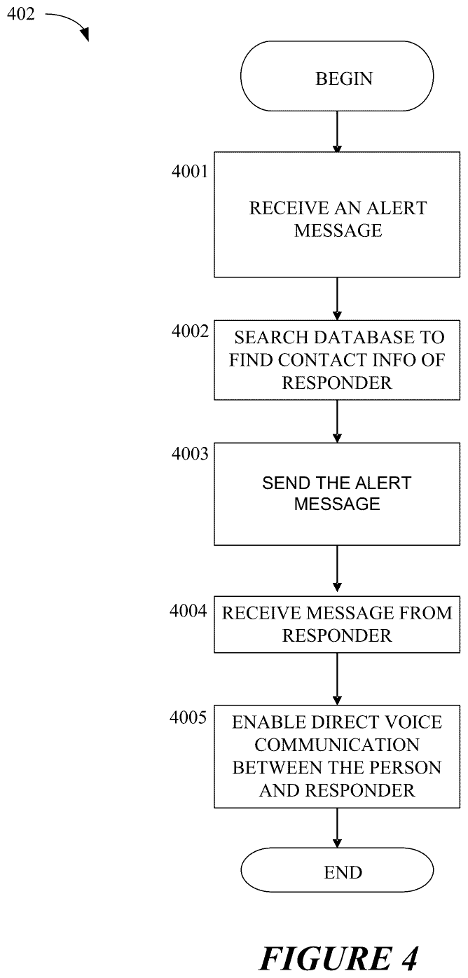

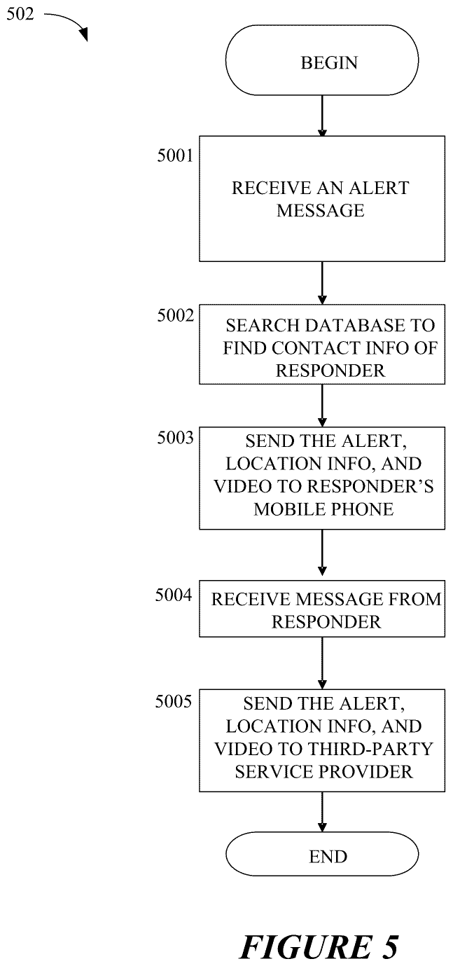

The central computer system 400 may take one or more actions based on the options selected by the responder 200. To illustrate the capability of the ULSS, another two different actions are taken by responder 200, as illustrated below based on FIG. 4 and FIG. 5.

FIG. 4 is a flow diagram illustrating an example of a process 402 for operations of the ULSS in accordance with various aspects of the present disclosure. In the example of FIG. 4, the alert sender 100 sends an alert message, intended for a responder 200, to the ULSS. In the example of FIG. 4, the elements of blocks 4001, 4002, 4003, and 4004 are similar to the elements of blocks 3001, 3002, 3003, and 3004 described with reference to FIG. 3. Therefore, for brevity, the descritpion of blocks 4001, 4002, 4003, and 4004 is omitted.

In the current example based on FIG. 4, in response to the option selected by responder 200, the central computer system 400 enables a direct voice communication (e.g., Voice-over-IP connection or SIP connection) between alert sender 100 and responder 200 (block 4005). A voice data communication module is incorporated into the mobile apps and the central computer system 400 so that alert sender 100 and responder 200 can talk to each other although their mobile apps use a data communication channel, rather than a telephone network. The data communication channel may be established by the central computer system 400. The communications may be encrypted to protect the confidentiality of the communications. The communication protocol ensures that the alert computer system, the responder computer system, and the central computer system correctly interpret the data packets transmitted and received among them (block 4005).

FIG. 5 is a flow diagram illustrating an example of a process 502 for the operations of the ULSS, in accordance with various aspects of the present dislcosure. In the example of FIG. 5, the elements of blocks 5001, 5002, 5003, and 5004 are similar to the elements of blocks 4001, 4002, 4003, and 4004 described with reference to FIG. 4, and also blocks 3001, 3002, 3003, and 3004 described with reference to FIG. 3. Therefore, for brevity, the description of blocks 5001, 5002, 5003, and 5004 is omitted.

In the example of FIG. 5, in response to the option selected by responder 200, the central computer system 400 sends the alert, the location information of alert sender 100, and a video clip taken by the mobile phone of alert sender 100 to the third-party service provider computer system 300 associated with a third-party service provider (block 5005). The third-party service provider may be, for example, an emergency department of a hospital, a family doctor of alert sender 100, a security company, or any other person or party that can rescue alert sender 100.

Although three different examples are used in FIGS. 3, 4, and 5, respectively, to explain the actions of the ULSS in response to the message from the responder, various other actions may be incorporated into the ULSS to help or save the alert sender 100.

For example, the alert sender 100 may get into an accident when she is traveling far away from home (e.g., when she is in a foreign country). Under such circumstances, the responder 200 may be far away from the alert sender 100 and cannot help the alert sender 100 in time. The ULSS can provide the responder 200 with a list of one or more agents who are near the location of alert sender 100 so that responder 200 can immediately contact one of the agents and arrange a mission to rescue alert sender 100.

For example, when responder 200 taps the name of one of the agents, the fee charges as well as the terms and conditions of the agent are listed on the mobile app of responder 200. Once responder 200 agrees with the terms and conditions of the agent, and pays the fees through the mobile app, the agent may immediately start the mission to rescue alert sender 100. The fees can be paid through credit cards, debits cards, virtual currency, or any type of financial instruments (e.g., cash, check, wire, ACH, etc.) that are commonly accepted in the business world.

In some aspects of the present disclosure, the ULSS permits the alert sender 100 to include the robotic team 500 as one of the responders. Under such circumstances, the central computer system 400 may dispatch the robotic team 500 to rescue the alert sender 100 after receiving an alert message from the alert sender 100. In general, the robotic team 500 may move faster than the human responders in the mission to save the alert sender 100.

In some aspects of the present disclosure, the ULSS includes the robotic team 500 as one of the options for a responder to choose. Once the responder has selected the robotic team option and agreed upon the terms and conditions, the central computer system 400 may dispatch the robotic team 500 to rescue the alert sender 100.

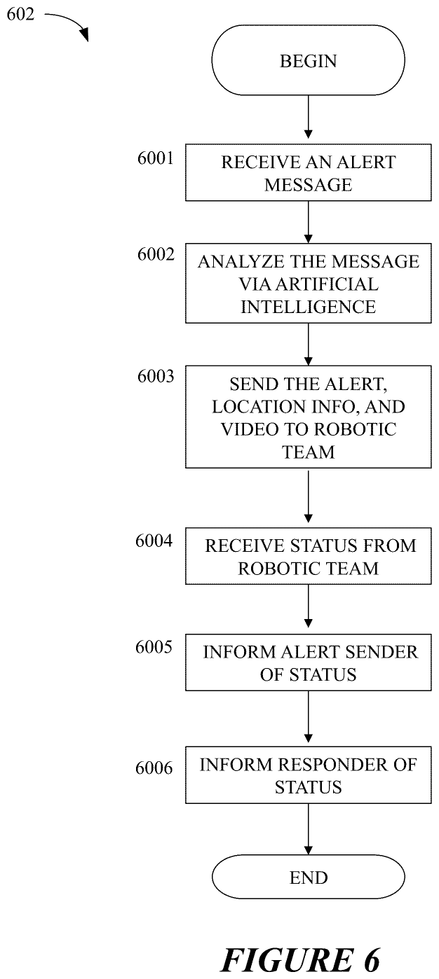

FIG. 6 is a flow diagram illustrating an example of a process 602 of the ULSS which sends the robotic team 500 to save the alert sender 100 because the robotic team 500 is one of the responders of the alert sender 100. In the example of FIG. 6, the alert sender 100 sends an alert message to all responders via the mobile application installed on the alert computer system. The alert sender 100 may generate an alert at the alert computer system. Then, the alert computer system may transmit an alert message to the central computer system 400. The alert message may include the alert, the location information of alert sender 100, and a video clip taken by the alert computer system. As a result, the central computer system 400 receives the alert message (block 6001). As discussed, the alert message may include the alert, the location information, and the environmental information (e.g., the video clip taken by the mobile phone of alert sender 100).

In response to receiving the alert message, because the ULSS is also a responder, the central computer system 400 uses an Artificial Intelligence module to analyze the information inside the message and determine the current situation of the alert sender (block 6002) so that the central computer system 400 may determine how to dispatch the robotic team 500 to save the alert sender 100. Additionally, the central computer system 400 obtains the contact information (e.g., the mobile phone number, mobile phone address, etc.) of the responder 200 from a database.

The central computer system 400 sends the alert, the location information, and the video clip to the robotic team computer system 500 which is a part of the ULSS (block 6003), then dispatches the robotic team 500 to rescue the alert sender 100. The robotic team 500 continues to send its status information to the central computer system 400 during the rescue mission. As a result, the central computer system 400 receives the status from the robotic team computer system (block 6004). In response to receiving the status from the robotic team 500, the central computer system 400 informs the alert sender 100 of the status (block 6005) so that the alert sender knows what is going on. The central computer system 400 also informs the responder 200 of the status (block 6005). The alert sender 100 and the responder 200 can also contribute their suggestions to the robotic team 500 during the rescue mission so that the robotic team 500 can achieve the goal of saving alert sender 200 with maximum effectiveness and efficiency.

In this disclosure, a threshold, a pre-defined value, or a parameter that may be set by a person, such as the designer, the user, etc., can also be set by the ULSS that learns the preferences of the user of the ULSS by evaluating past behavior of the user.

In this disclosure, the terminology “encoding” generally refers to any type of data manipulation so that an alphanumeric code is generated from a set of data through this data manipulation. The terminology “decoding” generally refers to the reverse data manipulation to transform the “encoded” data back to its original format. Not all encoded information can be decoded. Some coding schemes compress the information contained in the data, such that some information is lost during the encoding process. Sometimes, encoding involves encryption which hides the information such that it cannot be decoded or otherwise made visible without access to a description key.

In this disclosure, the terminology “network” generally refers to a communication network or networks, which can be wireless or wired, local area or wide area, voice or data, private or public, real time or non-real time, or a combination of them, and includes the well-known Internet.

In this disclosure, the terminology “Voice-over-IP (VOIP)” or “Session Initiation Protocol (SIP)” generally refers to a data communication technology in which a transmitter converts a combination of analog signals (e.g., voice) and digital signals into digital signals so that the digital signals can be sent through the data communication network. Then, the receiver of the digital signals can convert the received digital signals back into the combination of analog signals and digital signals. This technology enables people to communicate by voice, video, e-mail, text, etc. through a data communication network (e.g., a digital network).

In this disclosure, the terminology “computer” or “computer system” generally refers to either one computer or a group of computers, which may work alone or work together to accomplish the purposes of the system.

In this disclosure, the terminology “processor” generally refers to either one processor or a group of processors, which may work alone or work together to accomplish the purposes of the processor.

In this disclosure, the term “module” refers to a single component or multiple components which can be hardware, software, firmware, or a combination thereof, and may work alone or work together to accomplish the purposes of the module.

In this disclosure, a “bank” or “financial institution” generally refers to a financial service provider, either a bank or a non-bank, where financial services and money services are provided. Some examples of financial institutions are banks, credit unions, insurance companies, insurance agencies, stockbrokers, stock agencies, bond brokers, bond agencies, commodity brokers, commodity agencies, securities companies, mortgage companies, mortgage agencies, securities companies, money services businesses, agencies for money services businesses, agencies for organizations that provide financial services or money services, financial holding companies, trading companies, trading agencies, other financial service providers, other financial agencies, stock exchanges, commodity exchanges, securities exchanges, currency exchanges, virtual currency companies, virtual currency issuers, virtual currency service providers, virtual currency network providers, virtual currency computer providers, virtual currency dealers, virtual currency exchanges, virtual securities exchanges, bond exchanges, other exchanges, fund managers, investment companies, private equity firms, venture capital firms, merchant acquirers, payment processors, payment card issuers, payment card program managers, internet merchants, transactions processors, securities processors, other organizations related to financial services, etc.

In this disclosure, a “bank account” or “financial account” generally refers to an account associated with a financial institution, either a bank or a non-bank, where financial transactions can be conducted through financial instruments such as cash, virtual currency, virtual instruments, virtual securities, checks, credit cards, debit cards, ATM cards, stored value cards, gift cards, prepaid cards, wires, monetary instruments, letters of credit, notes, securities, commercial papers, commodities, securities, precious metal, electronic fund transfers, automatic clearing house, etc.

In this disclosure, “financial transactions” generally refer to transactions related to financial activities, including but not limited to payment, fund transfer, money services, securities issuance, securities exchange, currency exchange, commodity exchange, payroll, invoicing, trading, escrow, insurance, underwriting, merger, acquisition, account opening, account closing, account status check, etc.

In this disclosure, “financial instruments” generally refer to instruments that are used to conduct financial transactions, including instruments issued by financial institutions or non-financial institutions. Examples of financial instruments include cash, virtual currency, virtual securities, virtual instruments, credit cards, debit cards, ATM cards, prepaid cards, stored value cards, gift cards, checks, monetary instruments, wire transfers, ACH transfers, letters of credit, notes, securities, commercial papers, commodities, precious metal, gold, silver, etc.

In this disclosure, “trading” generally refers to trading activities, both private and public, including but not limited to trading of stock, currency, virtual currency, virtual instruments, virtual securities, commodities, rights, values, securities, derivatives, goods, services, merchandise, etc.

In this disclosure, “securities” are generally referred to according to the definition in the Securities Act of 1933 and other laws and regulations related to the Securities Act of 1933. For example, securities may generally include note, stock certificate, bond, debenture, check, draft, warrant, traveler's check, letter of credit, warehouse receipt, negotiable bill of lading, evidence of indebtedness, certificate of interest or participation in any profit-sharing agreement, collateral-trust certificate, preorganization certificate or subscription, transferable share, investment contract, voting-trust certificate; valid or blank motor vehicle title; certificate of interest in property, tangible or intangible; instrument or document or writing evidencing ownership of goods, wares, and merchandise, or transferring or assigning any right, title, or interest in or to goods, wares, and merchandise; or, in general, any instrument commonly known as a “security”, or any certificate of interest or participation in, temporary or interim certificate for, receipt for, warrant, or right to subscribe to or purchase any of the foregoing.

In this disclosure, a “consumer” generally refers to a customer, person, subject, payer, payee, beneficiary, user, or client, etc., seeking to perform a transaction with an individual, an organization, a merchant, and/or a financial institution.

In this disclosure, the terminology “identification document” generally refers to a passport, driver's license, voter card, benefits card, student identification card, social security card, national identification card, identity card, certificate of legal status, and other official documents and information bearing instruments that identify a designated individual by certain verifiable characteristics, that are issued or certified by a consulate, embassy, government agency, public or private organizations or other governmental authorities, and that are protected against unauthorized copying or alteration by the responsible party or parties. In particular, such “identification documents” can be formed from various materials, including paper, plastic, polycarbonate, PVC, ABS, PET, Teslin, composites, etc. and can embed the identification information in various formats, including printed or embossed on the document (or card), written on a magnetic medium, programmed into an electronic device, stored in a memory, and combinations thereof. The “identification information” may include, but is not necessarily limited to, names, identification numbers, date of birth, signatures, addresses, passwords, phone numbers, e-mail addresses, personal identification numbers, tax identification numbers, national identification numbers, countries that issue the IDs, states that issue the IDs, ID expiration date, photographs, fingerprints, iris scans, physical descriptions, and other biometric information. The embedded information can be read through optical, acoustic, electronic, magnetic, electromagnetic, and other media.

In this disclosure, “personal identification information” generally refers to name, address, date of birth, personal identification number, user ID, password, tax identification number, type of the identification document used, identity number associated with the identification document, country, state, government organization and/or a private organization issuing the identification document, expiration date of the identification document, phone number, screen name, e-mail address, photographs, fingerprints, iris scans, physical descriptions, biometrical information, and other information that can be used to identify a person.

In this disclosure, “personal information” includes personal identification information, personal relationships, personal status, personal background, personal interests, and personal financial information including information related to financial instruments, financial accounts and financial activities, and other information that is related to a person.

In this disclosure, a “personal communication device” generally refers to a device interface used for personal communication purposes.

In this disclosure, a “device interface” generally refers to a keyboard, a keypad, a monitor, a display, a terminal, a computer, a computer server, a control panel, a vehicle dash board, a network interface, a machinery interface, a video interface, an audio interface, an electrical interface, an electronic interface, a magnetic interface, an electromagnetic interface including electromagnetic wave interface, an optical interface, a light interface, an acoustic interface, a video interface, an audio interface, a contactless interface, a mobile phone interface, a smartphone interface, a smartbook interface, a tablet interface, other communication device interface, a Personal Digital Assistant (PDA) interface, a handheld device interface, a portable device interface, a wireless interface, a wired interface, and other interfaces.

In this disclosure, the terminology “terminal” or “kiosk” generally refers to equipment, including a computer and/or its peripherals, microprocessor and/or its peripherals, ATM terminal, check-cashing kiosk, money services kiosk, merchant checkout stand, cash register, coin exchange machine, parking lot payment kiosk, other payment kiosks, contactless device, wire line phone, mobile phone, smartphone, smartbook, tablet, personal communication device, tablet device, digital assistant, entertainment device, network interface device, router, and/or Personal Digital Assistant (PDA), etc., which interfaces a user with a computer network, so that the user may interact with computer systems and other equipment connected to the computer network.

In this disclosure, the terminology “computer application module” generally refers to a computer-based application, including a hardware application, a software application, or an application based on both hardware and software. A computer application module comprises Outlook, Gmail, Hotmail, Facebook, LinkedIn, or any application that is running on a mobile phone, a computer system, a personal computer, a smartbook, a personal communication device, a device interface, or a combination thereof.

In this disclosure, the terminology “communication channel” generally refers to a message communication channel, an e-mail communication channel, a webmail communication channel, a secure e-mail communication channel, a social network communication channel, a mobile app communication channel, a password-controlled communication channel, a virtual communication channel, a physical communication channel, an embedded communication channel, an electronic communication channel, an electromagnetic communication channel, a mechanic communication channel, a laser communication channel, a light communication, a video communication channel, an audio communication channel, a data communication channel, a voice communication channel, or a combination thereof.

The methodologies described may be implemented by various means depending upon the application. For example, these methodologies may be implemented in hardware, firmware, software, or any combination thereof. For a hardware implementation, the processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described, or a combination thereof.

For a firmware and/or software implementation, the methodologies may be implemented with modules (e.g., procedures, functions, and so on) that perform the functions described. Any machine-readable medium tangibly embodying instructions may be used in implementing the methodologies described. For example, software codes may be stored in a memory and executed by a processor. Memory may be implemented within the processor or external to the processor. As used the term memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM, DVD, or other optical disk storage, magnetic disk storage or other magnetic storage devices, or any other medium that can be used to store desired program code in the form of instructions or data structures and that can be accessed by a computer; disk and disc, as used, includes compact disc (CD), laser disc, optical disc, digital versatile disc (DVD), floppy disk and blue-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. The communication apparatus may not store all of the instructions and/or data on a computer readable medium.

The aspects described in this disclosure can be assembled to form a variety of applications based on the need. Those skilled in the art and technology to which this disclosure pertains can appreciate that alterations and changes in the described structure may be practiced without meaningfully departing from the principal, spirit, and scope of this disclosure. Such alterations and changes should not be construed as deviations from the present disclosure.

What is claimed is:

1. A method for alerting a responder by a first component, comprising:
using a voice recognition module of the first component to receive a verbal command from the person to send an alert;
using a location module of the first component to identify location information of the person in response to the verbal command;
using a video recorder of the first component to record environment information of the person in response to the verbal command;
using a predefined communication protocol to send the alert, the location information and the environment information to a second component through at least one computer communication network;
using an artificial intelligence module of the second component to analyze the alert, the location information, and the environment information;
using the artificial intelligence module of the second component to identify a method to rescue the person; and
instructing a drone to rescue the person based on the identified method to rescue the person.

2. The method of claim 1, in which each of the first component and the second component comprises at least one of a computer system, a personal communications device, a mobile phone, a device interface, or a combination thereof.

3. The method of claim 2, in which the device interface comprises a keyboard, a keypad, a monitor, a display, a terminal, a computer, a computer server, a control panel, a vehicle dash board, a network interface, a machinery interface, a video interface, an audio interface, an electrical interface, an electronic interface, a magnetic interface, an electromagnetic interface including electromagnetic wave interface, an optical interface, a light interface, an acoustic interface, a video interface, an audio interface, a contactless interface, a mobile phone interface, a smartphone interface, a smartbook interface, a tablet interface, other communication device interface, a Personal Digital Assistant (PDA) interface, a handheld device interface, a portable device interface, a wireless interface, a wired interface, and other interfaces.

4. A method for alerting a responder by a central computer system, comprising:
receiving, from an alert computer system, an alert message including an alert and related information;
identifying the responder associated with the alert computer system;
transmitting, to a responder computer system associated with the responder, the alert message based on identifying the responder;
receiving, from the responder computer system, a first message confirming receipt of the alert message; and
establishing a voice data communication channel between the alert computer system and the responder computer system based on receiving the first message.

5. The method of claim 4, in which each of the central computer system, the alert computer system, and the responder computer system comprises at least one of a computer system, a personal communications device, a mobile phone, a device interface, or a combination thereof.

6. The method of claim 5, in which the device interface comprises a keyboard, a keypad, a monitor, a display, a terminal, a computer, a computer server, a control panel, a vehicle dash board, a network interface, a machinery interface, a video interface, an audio interface, an electrical interface, an electronic interface, a magnetic interface, an electromagnetic interface including electromagnetic wave interface, an optical interface, a light interface, an acoustic interface, a video interface, an audio interface, a contactless interface, a mobile phone interface, a smartphone interface, a smartbook interface, a tablet interface, other communication device interface, a Personal Digital Assistant (PDA) interface, a handheld device interface, a portable device interface, a wireless interface, a wired interface, and other interfaces.

7. The method of claim 4, further comprising receiving, from the alert computer system prior to receiving the alert message, a second message identifying the responder, the second message including contact information associated with the responder computer system.

8. The method of claim 4, in which the responder is a non-emergency personnel.

9. The method of claim 4, in which the related information includes one or more of location information of the alert computer system or environmental information.

10. The method of claim 9, in which the location information is collected by at least one of a GPS module and a cellular geolocation module associated with the alert computer system.

11. The method of claim 9, in which the environmental information includes one or more of an image, a video, or an audio recording captured by one or more recording devices associated with the alert computer system.

12. A method for alerting a responder by a central computer system, comprising:
receiving, from an alert computer system, an alert message including an alert and related information;
identifying the responder associated with the alert computer system;
transmitting, to a responder computer system associated with the responder, the alert message based on identifying the responder;
receiving, from the responder computer system, a first message requesting assistance from a third-party responder;
transmitting, to a third-party computer system associated with the third-party responder, the alert message; and
establishing a voice data communication channel between the alert computer system and one or both of the responder computer system and the third-party computer system.

13. The method of claim 12, in which each of the central computer system, the alert computer system, the third-party computer system, and the responder computer system comprises at least one of a computer system, a personal communications device, a mobile phone, a device interface, or a combination thereof.

14. The method of claim 13, in which the device interface comprises a keyboard, a keypad, a monitor, a display, a terminal, a computer, a computer server, a control panel, a vehicle dash board, a network interface, a machinery interface, a video interface, an audio interface, an electrical interface, an electronic interface, a magnetic interface, an electromagnetic interface including electromagnetic wave interface, an optical interface, a light interface, an acoustic interface, a video interface, an audio interface, a contactless interface, a mobile phone interface, a smartphone interface, a smartbook interface, a tablet interface, other communication device interface, a Personal Digital Assistant (PDA) interface, a handheld device interface, a portable device interface, a wireless interface, a wired interface, and other interfaces.

15. The method of claim 12, in which:
the responder is a non-emergency personnel; and
the third-party responder is an emergency personnel.

16. A networked system for rescuing a person in danger, comprising:
a voice recognition module of a first component to receive a verbal command from the person to send an alert;
at least one of a GPS module and a cellular geolocation module of the first component to identify location information of the person in response to the verbal command;
a video recorder of the first component to record environment information of the person in response to the verbal command;
at least one computer communication network to send the alert, the location information and the environment information from the first component to the second component based on a predefined communication protocol;
an artificial intelligence module of the second component to analyze the alert, the location information, and the environment information to identify a method to rescue the person; and
a drone to rescue the person based on the identified method to rescue the person.

17. An apparatus for alerting a responder via a central computer system, comprising:
a processor; and
a memory coupled with the processor and storing instructions operable, when executed by the processor, to cause the apparatus:
to receive, from an alert computer system, an alert message including an alert and related information;
to identify the responder associated with the alert computer system;
to transmit, to a responder computer system associated with the responder, the alert message based on identifying the responder;
to receive, from the responder computer system, a first message confirming receipt of the alert message; and
to establish a voice data communication channel between the alert computer system and the responder computer system based on receiving the first message.

18. An apparatus for alerting a responder via a central computer system, comprising:
a processor; and
a memory coupled with the processor and storing instructions operable, when executed by the processor, to cause the apparatus:
to receive, from an alert computer system, an alert message including an alert and related information;
to identify the responder associated with the alert computer system;
to transmit, to a responder computer system associated with the responder, the alert message based on identifying the responder;
to receive, from the responder computer system, a first message requesting assistance from a third-party responder;
to transmit, to a third-party computer system associated with the third-party responder, the alert message; and
to establish a voice data communication channel between the alert computer system and one or both of the responder computer system the third-party computer system, or the robotic team computer system.

19. A non-transitory computer-readable medium having program code recorded thereon for alerting a responder via a central computer system, the program code executed by a processor and comprising:
program code for a voice recognition module of a first component to receive a verbal command from the person to send an alert;
program code for at least one of a GPS module and a cellular geolocation module of the first component to identify location information of the person in response to the verbal command;
program code for a video recorder of the first component to record environment information of the person in response to the verbal command;
program code based on a predefined communication protocol to send the alert, the location information and the environment information to a second component through at least one computer communication network;
program code based on artificial intelligence to analyze the alert, the location information, and the environment information;
program code based on artificial intelligence to identify a method to rescue the person; and
program code to instruct a drone to rescue the person based on the identified method to rescue the person.

20. A non-transitory computer-readable medium having program code recorded thereon for alerting a responder via a central computer system, the program code executed by a processor and comprising:
program code to receive, from an alert computer system, an alert message including an alert and related information;
program code to identify the responder associated with the alert computer system;
program code to transmit, to a responder computer system associated with the responder, the alert message based on identifying the responder;
program code to receive, from the responder computer system, a first message confirming receipt of the alert message; and
program code to establish a voice data communication channel between the alert computer system and the responder computer system based on receiving the first message.

21. A non-transitory computer-readable medium having program code recorded thereon for alerting a responder via a central computer system, the program code executed by a processor and comprising:
program code to receive, from an alert computer system, an alert message including an alert and related information;
program code to identify the responder associated with the alert computer system;
program code to transmit, to a responder computer system associated with the responder, the alert message based on identifying the responder;
program code to receive, from the responder computer system, a first message requesting assistance from a third-party responder;
program code to transmit, to a third-party computer system associated with the third-party responder, the alert message; and
program code to establish a voice data communication channel between the alert computer system and one or both of the responder computer system the third-party computer system, or the robotic team computer system.

22. A method for generating an alert by an alert computer system, comprising:
receiving an input triggering the alert;
transmitting, to a central computer system, an alert message including the alert and related information; and
establishing a voice data communication channel between the alert computer system and a responder computer system based on transmitting the alert message.

23. The method of claim 22, in which each of the central computer system, the alert computer system, and the responder computer system comprises at least one of a computer system, a personal communications device, a mobile phone, a device interface, or a combination thereof.

24. The method of claim 23, in which the device interface comprises a keyboard, a keypad, a monitor, a display, a terminal, a computer, a computer server, a control panel, a vehicle dash board, a network interface, a machinery interface, a video interface, an audio interface, an electrical interface, an electronic interface, a magnetic interface, an electromagnetic interface including electromagnetic wave interface, an optical interface, a light interface, an acoustic interface, a video interface, an audio interface, a contactless interface, a mobile phone interface, a smartphone interface, a smartbook interface, a tablet interface, other communication device interface, a Personal Digital Assistant (PDA) interface, a handheld device interface, a portable device interface, a wireless interface, a wired interface, and other interfaces.

25. The method of claim 24, further comprising transmitting, to the central computer system prior to transmitting the alert message, a message identifying a responder, the message including contact information associated with the responder computer system.

26. The method of claim 25, in which the responder is a non-emergency personnel.

27. The method of claim 22, in which the related information includes one or more of location information of the alert computer system or environmental information.

28. The method of claim 27, in which the location information is collected by a location device associated with the alert computer system.

29. The method of claim 27, in which the environmental information includes one or more of an image, a video, or an audio recording captured by one or more recording devices associated with the alert computer system.

30. The method of claim 22, in which the input is a tactile input received at the alert computer system.

31. The method of claim 22, in which the input is a voice input.
